(19) United States
(12) Patent Application Publication
(10) Pub. No.: US 2009/0288447 A1
(43) Pub. Date: Nov. 26, 2009

(54) OPERATION OF A FROSTING VESSEL OF AN ANTI-SUBLIMATION SYSTEM

(75) Inventor: Wolfgang G. Hees, Malmo (SE)

Correspondence Address: ALSTOM POWER INC.;INTELLECTUAL PROPERTY LAW DEPT., P.O. BOX 500, WINDSOR, CT, 06095, US

(73) Assignee: ALSTOM TECHNOLOGY LTD, Baden (CH)

(21) Appl. No.: 12/463,030

(22) Filed: May 8, 2009

Related U.S. Application Data
(60) Provisional application No. 61/055,163, filed on May 22, 2008.

(51) Int. Cl. B01D 9/04; F25D 31/00

(52) U.S. Cl. 62/532; 62/440

(57) ABSTRACT

Method for operating a frosting vessel of an anti-sublimation system for capturing CO₂ from a gas stream. During defrosting of CO₂ ice present in the frosting vessel CO₂ gas is removed from the frosting vessel. Anti-sublimation system for capturing CO₂ from a gas stream. Said anti-sublimation system comprises a frosting vessel and means for removing CO₂ gas from the frosting vessel. Said means is adapted to remove CO₂ gas during defrosting of CO₂ ice present in the frosting vessel. Flue gas treatment system comprising one or more heat exchangers for lowering the temperature of the flue gas and one or more scrubbers for removing contaminants from the flue gas. Said flue gas treatment system further comprises the above-mentioned anti-sublimation system.

### CROSS-REFERENCE TO RELATED APPLICATION

This application claims the benefit of U.S. Provisional Patent Application Ser. No. 61/055,163 filed May 22, 2008, which is hereby incorporated by reference in its entirety.

### TECHNICAL FIELD

The present invention relates to a method for operating a frosting vessel of an anti-sublimation system for capturing CO₂ from a gas stream and to an anti-sublimation system for capturing CO₂ from a gas stream, said anti-sublimation system comprising a frosting vessel. The present invention also relates to a flue gas treatment system.

### BACKGROUND ART

Carbon dioxide (CO₂) capture in known anti-sublimation systems is done by frosting CO₂ ice on cold surfaces inside one or more frosting vessels and subsequently defrosting the CO₂ by warming up these same surfaces. Existing technology foresees frosting vessels to be pressure vessels and operate at pressures significantly higher than atmospheric pressure, thereby necessitating expensive design solutions, such as thick vessel walls, stiffening rings and valves and fittings rated for high pressure.

U.S. Pat. No. 7,073,348 pertains to a method and a system for extracting carbon dioxide from fumes derived from the combustion of hydrocarbons in an apparatus designed in particular for the production of mechanical energy. The method comprises the step of cooling said fumes at a pressure more or less equal to atmospheric pressure at a temperature such that the carbon dioxide passes directly from the vapor state to the solid state via an anti-sublimation process. During the anti-sublimation phase, CO₂ frost is formed in an anti-sublimation evaporator. The procedure of preparing the anti-sublimation evaporator for a next cycle of anti-sublimation of CO₂ contained in the fumes is summarized as follows. The solid CO₂ melts, i.e. passes from the solid phase to the liquid phase at a pressure of 5.2 bar. Once the CO₂ is entirely in the liquid phase, it is transferred by a pump to into a heat-insulated reservoir.

US 2006/0277942 provides a disclosure which is largely similar to that of U.S. Pat. No. 7,073,348, however relating to extraction of sulfur dioxide as well as carbon dioxide.

### SUMMARY OF THE INVENTION

An object of the present invention is to improve the operation of a frosting vessel of an anti-sublimation system for capturing CO₂, in particular as concerns the defrosting of CO₂ ice present in the frosting vessel.

Another object of the present invention is to allow for a lighter, and thus cheaper, design of a frosting vessel of an anti-sublimation system for capturing CO₂.

Another object of the present invention is to provide a design and a mode of operation of an anti-sublimation system for capturing CO₂ allowing defrosting of CO₂ ice present in the frosting vessel at a lower pressure than previously considered.

As has become common in this technical field, the term “anti-sublimation” herein refers to a direct gas/solid phase change that occurs when the temperature of the gas in question is below that of its triple point. The term “sublimation” herein refers, as is conventional, to a direct solid/gas phase change.

The term “defrosting” herein refers to a transformation of ice to another state. In particular it is referred to the transformation of CO₂ ice, i.e. solid CO₂, to another state,

In the present context, the term “gas stream” may refer to a stream of any gas mixture comprising CO₂. A “gas stream” may, however, typically be a stream of a flue gas resulting from combustion of organic material such as renewable or non-renewable fuels. Should a gas stream to be treated according to the present invention comprise chemical species or particles not suitable in an anti-sublimation system, or not suitable to other features of the present invention, such species or particles may be initially removed by separation technologies known to a skilled man.

The above-mentioned objects as well as further objects, which will become apparent to a skilled person after studying the description below, are achieved, in a first aspect, by a method for operating a frosting vessel of an anti-sublimation system for capturing CO₂ from a gas stream, wherein during defrosting of CO₂ ice present in the frosting vessel CO₂ gas is removed from the frosting vessel.

By removal of CO₂ gas from the frosting vessel during defrosting of CO₂ ice the internal pressure of the frosting vessel is kept lower than what would otherwise be possible. As an advantageous consequence, the frosting vessel may be designed to withstand a lower pressure than known frosting vessels. Accordingly, the frosting vessel and its associated piping and fittings may be of lighter design and thus cheaper.

The proposed method may be interpreted as a new manner of operating a frosting vessel, wherein said defrosting is performed by transformation of CO₂ ice present in the frosting vessel to CO₂ gas, i.e. by sublimation.

The operation of the frosting vessel may be such that during said defrosting the frosting vessel is maintained at an internal pressure of lower than about 50 kPa above atmospheric pressure, preferably lower than about 25 kPa above atmospheric pressure, more preferably lower than about 10 kPa above atmospheric pressure, and most preferably of about atmospheric pressure. It is of constructional and economical advantage to operate the frosting vessel at an internal pressure close to atmospheric pressure. Conveniently, CO₂ gas may be removed from the frosting vessel in such an amount that the frosting vessel is maintained at said internal pressure.

Depending on the pressure conditions in the frosting vessel during said defrosting as well as the pressure conditions at the intended destination of CO₂ removed from the frosting vessel, it may be required that CO₂ gas is removed from the frosting vessel by pumping. As used herein, “pumping” includes the action performed by any kind of gas pumping equipment, such as gas pumps, blowers or compressors. Considering that captured CO₂ is preferably stored and/or further handled (e.g., transported) at pressures high enough for the CO₂ to be in its in liquid state, the pumping may transform the CO₂ gas removed from the frosting vessel to liquid CO_{2.} Thus, the pumping operation may involve compressive action, such as the action exerted by a compressor. Resulting liquid CO₂ may conveniently be passed to a storage vessel. Should N₂ or other gases be present along with CO₂ removed from the frosting vessel, these gases may be removed by gas/liquid separation after formation of liquid CO₂.

The objects of the present invention are also achieved, in a second aspect, by an anti-sublimation system for capturing CO₂ from a gas stream, said anti-sublimation system comprising a frosting vessel and means for removing CO₂ gas from the frosting vessel, said means being adapted to remove CO₂ gas during defrosting of CO₂ ice present in the frosting vessel.

Being adapted to remove CO₂ gas during defrosting of CO₂ ice present in the frosting vessel, the means for removing CO₂ gas provides a possibility to operate the frosting vessel at a lower internal pressure than what would otherwise be possible. As an advantageous consequence, the frosting vessel may be designed to withstand a lower pressure than known frosting vessels. Accordingly, the frosting vessel and its associated piping and fittings may be of lighter design and thus cheaper.

The anti-sublimation system may comprise more than one frosting vessel of the design and function disclosed herein. Typically, it is desirable to equip an anti-sublimation system with two frosting vessels in order to be able to defrost CO₂ ice in one frosting vessel while CO₂ is captured from a gas stream in another.

Depending on the pressure conditions in the frosting vessel during said defrosting as well as the pressure conditions at the intended destination of CO₂ removed from the frosting vessel, it may be required that the means for removing CO₂ gas from the frosting vessel is a pump, and the inlet of the pump is connected to the frosting vessel. As used herein, “pump” includes any kind of gas pumping equipment, such as gas pumps, blowers or compressors. Considering that captured CO₂ is preferably stored and/or further handled (e.g., transported) at pressures high enough for the CO₂ to be in its liquid state, the pump may be a compressor adapted to transform the CO₂ gas removed from the frosting vessel to liquid CO₂. Thus, vessels, piping and fittings after the pump need to be pressure rated accordingly. Conveniently, the anti-sublimation system may further comprise a storage vessel connected to the outlet of the compressor and adapted to receive the liquid CO₂. A gas/liquid separator may be fitted downstream the compressor adapted to transform the CO₂ gas removed from the frosting vessel to liquid CO₂. Thus, N₂ or other gases possibly present along with CO₂ removed from the frosting vessel may be removed by gas/liquid separation after formation of liquid CO₂.

The anti-sublimation system may be such that the frosting vessel is adapted to operate only at an internal pressure of lower than about 50 kPa above atmospheric pressure, preferably lower than about 25 kPa above atmospheric pressure, more preferably lower than about 10 kPa above atmospheric pressure, and most preferably of about atmospheric pressure. It is of constructional and economical advantage to operate the frosting vessel at an internal pressure close to atmospheric pressure. Thus, the anti-sublimation system may be such that the frosting vessel is designed and equipped for a maximum allowable pressure not greater than 50 kPa above atmospheric pressure, preferably not greater than 25 kPa above atmospheric pressure, more preferably not greater than 10 kPa above atmospheric pressure.

The objects of the present invention are also achieved, in a third aspect, by a flue gas treatment system comprising one or more heat exchangers for lowering the temperature of the flue gas and one or more scrubbers for removing contaminants from the flue gas, said flue gas treatment system further comprising an anti-sublimation system as defined above. Typically, the flue gas treatment system may comprise an integrated cascade cooling system which may provide the cold necessary to frost CO₂ ice in the frosting vessel.

### BRIEF DESCRIPTION OF THE DRAWING

FIG. 1 is a schematic view of an anti-sublimation system for capturing CO₂ from a gas stream.

### DETAILED DESCRIPTION

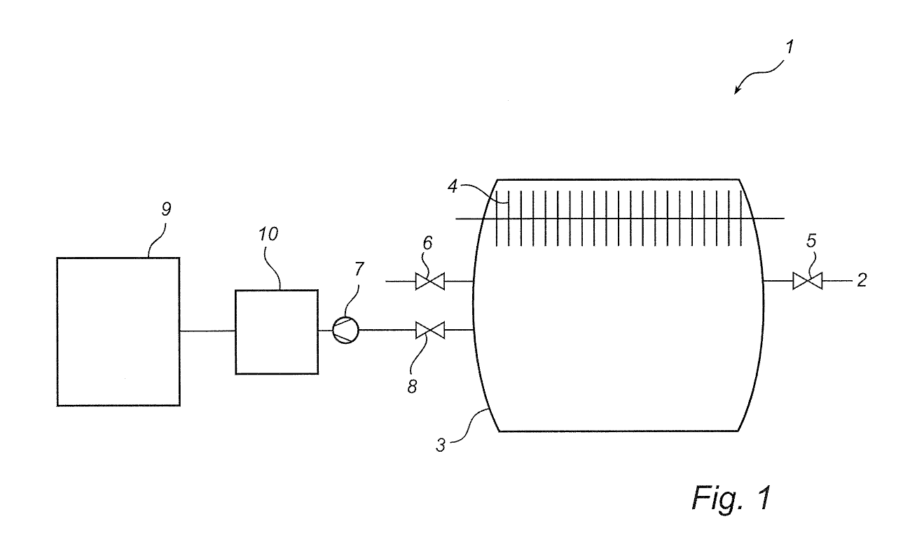

An embodiment of an anti-sublimation system according to the invention will be described with reference to FIG. 1. An anti-sublimation system 1 for capturing CO₂ from a gas stream 2 comprises a frosting vessel 3 with internal cold surfaces 4. The gas stream 2 may be passed through the frosting vessel 3 via valves 5, 6. The frosting vessel 3 is a vessel adapted for operation at internal pressures lower than 50 kPa. The inlet of a pump 7 is connected to the frosting vessel 3 via a valve 8. The outlet of the pump 7 is connected to a storage vessel 9. A gas/liquid separator 10 is fitted between the outlet of the pump 7 and the storage vessel 9.

During frosting of CO₂ ice on the internal cold surfaces 4, valves 5, 6 are open and a gas stream 2 comprising CO₂ is passed through the frosting vessel 3. The temperature of the gas entering the frosting vessel 3 may be about −100° C., whereas the internal cold surfaces 4 may be kept at about −120° C. Anti-sublimation occurs so that CO₂ gas in the gas stream is transformed to CO₂ ice. During frosting of CO₂ ice, the pump 7 is not used and valve 8 is closed. When the frosting capacity of the frosting vessel 3 is reached, valves 5, 6 are closed and the gas stream 2 is no longer passed through the frosting vessel 3 but may be passed to another frosting vessel (not shown) where frosting may be continued.

During defrosting of CO₂ ice present in the frosting vessel 3, valves 5, 6 are closed and the gas stream 2 is no longer passed through the frosting vessel. The temperature of the internal cold surfaces 4 may be raised to about −45° C. Sublimation occurs so that CO₂ ice is transformed to CO₂ gas. During defrosting of CO₂ ice, valve 8 is open and the pump 7 relieves the frosting vessel of CO₂ gas so that the internal pressure of the frosting vessel is kept below 50 kPa. This allows the frosting vessel and its associated piping and fittings to be made more cheaply and lighter, because they do not have to withstand elevated pressure levels. The pump 7 exerts compressing action so that it delivers liquid CO₂. The liquid CO₂ is collected in storage vessel 9. Residual N₂ is removed by the gas/liquid separator 10 before the liquid CO₂ is collected in storage vessel 9.

When the CO₂ ice in the frosting vessel 3 has been defrosted and removed, the gas stream 2 may again pass through the frosting vessel and frosting be repeated.

1. Method for operating a frosting vessel of an anti-sublimation system for capturing CO₂ from a gas stream, wherein during defrosting of CO₂ ice present in the frosting vessel CO₂ gas is removed from the frosting vessel.

2. Method according to claim 1, wherein said defrosting is performed by transformation of CO₂ ice present in the frosting vessel to CO₂ gas.

3. Method according to claim 1, wherein during said defrosting the frosting vessel is maintained at an internal pressure of lower than about 50 kPa above atmospheric pressure, preferably lower than about 25 kPa above atmospheric pressure, more preferably lower than about 10 kPa above atmospheric pressure, and most preferably of about atmospheric pressure.

4. Method according to claim 3, wherein CO₂ gas is removed from the frosting vessel in such an amount that the frosting vessel is maintained at said internal pressure.

5. Method according to claim 1, wherein CO₂ gas is removed from the frosting vessel by pumping.

6. Method according to claim 4, wherein the pumping transforms the CO₂ gas removed from the frosting vessel to liquid CO₂.

7. Method according to claim 6, wherein the liquid CO₂ is passed to a storage vessel.

8. Anti-sublimation system for capturing CO₂ from a gas stream, said anti-sublimation system comprising a frosting vessel and means for removing CO₂ gas from the frosting vessel, said means being adapted to remove CO₂ gas during defrosting of CO₂ ice present in the frosting vessel.

9. Anti-sublimation system according to claim 8, wherein the means for removing CO₂ gas from the frosting vessel is a pump, and the inlet of the pump is connected to the frosting vessel.

10. Anti-sublimation system according to claim 9, wherein the pump is a compressor adapted to transform the CO₂ gas removed from the frosting vessel to liquid CO₂.

11. Anti-sublimation system according to claim 10, further comprising a storage vessel connected to the outlet of the compressor and adapted to receive the liquid CO₂.

12. Anti-sublimation system according to claim 8, wherein the frosting vessel is adapted to operate only at an internal pressure of lower than about 50 kPa above atmospheric pressure, preferably lower than about 25 kPa above atmospheric pressure, more preferably lower than about 10 kPa above atmospheric pressure, and most preferably of about atmospheric pressure.

13. (canceled)

14. (canceled)
